(19) United States
(12) Patent Application Publication
(10) Pub. No.: US 2007/0132652 A1
(43) Pub. Date: Jun. 14, 2007

(54) ANTENNA UNIT AND PORTABLE COMMUNICATION EQUIPMENT

(75) Inventors: Hajime Shimada, Yokohama-shi, Kanagawa (JP); Hiroki Satou, Yokohama-shi, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/566,700

(22) Filed: Dec. 5, 2006

(30) Foreign Application Priority Data
Dec. 13, 2005 (JP) 2005-358746

(51) Int. Cl. H01Q 1/00; G08B 13/14

(52) U.S. Cl. 343/787; 340/572.7

(57) ABSTRACT

An antenna unit includes a noncontact communication antenna and a plurality of magnetic elements provided on the antenna. The antenna and the magnetic elements are disposed so that the magnetic elements are superposed on the antenna.

### BACKGROUND OF THE INVENTION

The present invention relates to an antenna for noncontact communication antenna and, more particularly, to a portable communication equipment for noncontact communication, which has the antenna.

Recently, there have been increasing demands for a communication system (hereunder referred to a “proximity noncontact communication system”) capable of, for example, copying electronic data representing personal information such as telephone directory data to a portable telephone, reading and writing personal information from and to an electronic carte at a hospital and a pharmacy, browsing electronic resident registration data, requesting for a copy of a resident card or a family register, transferring, copying and storing personal hobby data (various kinds of music data and picture data) to, onto and in a person's own portable telephone, inputting money amount data to a desired electronic device as prepaid amount data for automatic vending machines, or being used as a pass at entrance gates of an amusement park and a station. This communication system performs communication with an opponent party by officially being positioned close to the opponent party to the extent that the communication system touches or adheres tightly to the opponent party, and by utilizing an electric or magnetic field in a proximity region, the distance from the communication system to each point of which is equal to or less than about 10 cm by which the electric or magnetic field thereof effectively acts.

Thus, there have been studies on the development of various kinds of portable communication equipments having the proximity noncontact communication function of enabling proximity noncontact communication with an external proximity noncontact communication device serving as an opponent party (hereunder abbreviated as an “external proximity noncontact communication device”).

Also, the proximity noncontact communication can utilize a magnetic field. Generally, a loop antenna is used as a proximity noncontact communication antenna. However, the loop antenna is susceptible to the influence of an electrically conductive material. In a case where there is an electric plate or the like is present in the proximity of the loop antenna, the communication distance in the case of the proximity noncontact communication is reduced. Especially, in a case where a portable communication equipment has the proximity noncontact communication function, the communication distance in the case of the proximity noncontact communication is reduced, because the portable communication equipment has a large number of electrically conductive materials provided therein.

Therefore, as a measure to reduce the influence of the metallic plate provided in the vicinity of the loop antenna, a magnetic element is preliminarily provided on the rear surface of a proximity noncontact communication antenna, as described in JP-A-2003-141466.

FIG. 11 shows the structure of an antenna disclosed in JP-A-2003-141466. The proximity noncontact communication antenna unit is formed by superposing the proximity noncontact communication antenna with the magnetic element. In a case where this antenna unit is mounted in a portable communication equipment, it is necessary for ensuring desired proximity noncontact communication characteristics to reduce the influence of the electrically conductive material provided in the portable communication equipment. To alleviate the influence of the electrically conductive material, it is necessary to thicken the magnetic element or to increase the size in a planar direction of the proximity noncontact communication antenna. This antenna unit has a problem that the body of the portable communication equipment placing importance on portability should be increased in thickness or size.

Incidentally, as shown in FIG. 11, a proximity noncontact communication antenna unit 200 is configured so that an antenna pattern 11 is formed on an antenna substrate 10. A bonding layer 16 and a magnetic element 17 are stacked in this order on a surface of the antenna substrate 10, which is opposite to the surface on which the antenna pattern 11 is provided. An arrow a shown in FIG. 11 indicates the thickness of the magnetic element 17.

FIG. 2 shows actual measurement values of communication distance characteristics in a case where the thickness a of the magnetic element 17 is changed among four kinds of values. The communication distance characteristic (1) corresponds to a case where the thickness of the magnetic element 17 is 0.14 mm. The communication distance characteristic (2) corresponds to a case where the thickness of the magnetic element 17 is 0.21 mm. The communication distance characteristic (3) corresponds to a case where the thickness of the magnetic element 17 is 0.28 mm. The communication distance characteristic (4) corresponds to a case where the thickness of the magnetic element 17 is 0.35 mm. As is understood from data shown in FIG. 2, the communication distance in the case of the proximity noncontact communication increases in proportion to increase in the thickness of the magnetic element 17.

### SUMMARY OF THE INVENTION

The invention solves the problems of the conventional antenna. Accordingly, an object of the invention is to reduce the thickness and the size of a proximity noncontact communication antenna unit in consideration of mounting a proximity noncontact communication antenna for a proximity noncontact communication system in a portable communication equipment.

To achieve the foregoing object, according to the invention, there is provided a noncontact communication antenna unit which includes a noncontact communication antenna and a plurality of magnetic elements. The antenna and the plurality of magnetic elements are disposed so that the plurality of magnetic elements are superposed on the antenna.

With this configuration, the influence of a metal plate placed close to the antenna unit can be reduced. Also, the thickness of the proximity noncontact communication antenna can be reduced.

In the antenna unit according to the invention, the plurality of magnetic elements may differ in thickness from one another. Also, the plurality of magnetic elements may be disposed so that the thickness of the magnetic element placed relatively closer to the antenna is larger than that of the magnetic element placed relatively further from the antenna. Preferably, the plurality of magnetic elements are disposed in the descending order of thickness from the side of the antenna.

With this configuration, in a case where the plurality of magnetic elements differ in thickness from one another, the influence of the metal plate can be reduced even when the antenna unit has the same thickness. Also, the proximity noncontact communication antenna unit can be reduced in thickness.

In the noncontact communication antenna unit according to the invention, the plurality of magnetic elements may differ in magnetic permeability from one another. Also, the plurality of magnetic elements may be disposed so that the magnetic permeability of the magnetic element placed relatively closer to the antenna is higher than that of the magnetic element placed relatively further from the antenna. Preferably, the plurality of magnetic elements are disposed in the descending order of magnetic permeability from the side of the antenna.

With this configuration, in a case where the plurality of magnetic elements differ in magnetic permeability from one another, the influence of the metal plate can be reduced even when the antenna unit has the same thickness.

Also, the proximity noncontact communication antenna unit can be reduced in thickness.

In a case where the plurality of magnetic elements differ in thickness and magnetic permeability from one another, the noncontact communication antenna unit according to the invention is configured so that the plurality of magnetic elements are disposed in the descending order of magnetic permeability and thickness from the side of the antenna.

With this configuration, in a case where the plurality of magnetic elements differ in magnetic permeability and thickness from one another, the influence of the metal plate can be reduced even when the antenna unit has the same thickness. Also, the proximity noncontact communication antenna unit can be reduced in thickness.

As described above, according to the invention, the plurality of magnetic elements are superposed on the proximity noncontact communication antenna substrate in the antenna unit. Consequently, the invention has advantages in that the proximity noncontact communication antenna can be reduced in thickness, and that when the portable communication equipment has the proximity noncontact communication function, the communication characteristic thereof are difficult to be affected by the electrically conductive materials provided in the portable communication equipment, and a desired communication distance in the case of the proximity noncontact communication can be ensured.

### BRIEF DESCRIPTION OF THE DRAWINGS

Further objects and advantages of the invention will be apparent from the following description of the preferred embodiments of the invention as illustrated in the accompanying drawings:

FIG. 1 is a cross-sectional view illustrating an antenna according to a first embodiment of the invention;

FIG. 2 is a graph illustrating communication distance data in the case of proximity noncontact communication corresponding to each thickness of a magnetic element;

FIG. 3 is a graph illustrating characteristic data according to the first embodiment of the invention;

FIG. 4 is another graph illustrating characteristic data according to the first embodiment of the invention;

FIG. 5 is a graph illustrating characteristic data according to a second embodiment of the invention;

FIG. 6 is another graph illustrating characteristic data according to the first embodiment of the invention;

FIG. 7 is a graph illustrating characteristic data according to a third embodiment of the invention;

FIG. 8 is a view illustrating the distribution of a magnetic field according to prior art;

FIG. 9 is a view illustrating the distribution of a magnetic field according to each of the first, second, and third embodiments of the invention;

FIG.10 is a cross-sectional view illustrating a portable communication equipment according to the first embodiment of the invention; and

FIG. 11 is a cross-sectional view illustrating an antenna according to the prior art.

### DETAILED DESCRIPTION OF THE PREFERRED EMBODIMENTS

Hereinafter, embodiments of the invention are described in detail with reference to the accompanying drawings.

### First Embodiment

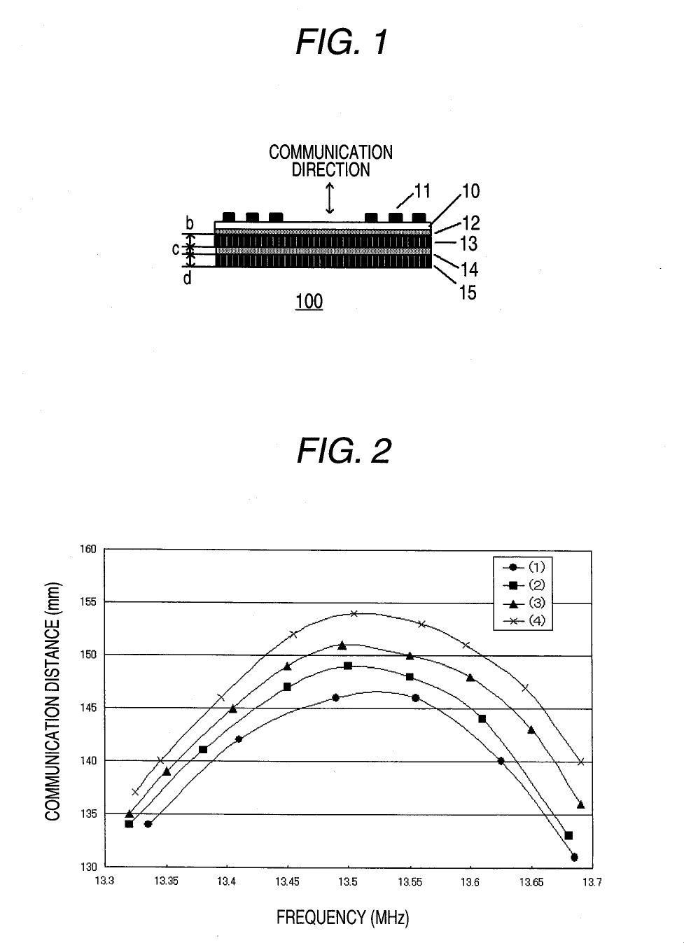

FIGS. 1, 3, 4, 6, 8, 9, and 10 illustrate a proximity noncontact communication antenna unit 100, a portable communication equipment 300 having a proximity noncontact communication function, and an external proximity noncontact communication device 400.

The portable communication equipment 300 shown in FIG. 10 has both a portable telephone function of serving as an ordinary portable telephone, and a proximity noncontact communication function of serving as a portable communication equipment. A housing portion of the portable communication equipment 300 includes a straight-bar-like main housing 301 having an operation keys (not shown) and an LCD (not shown). (Although the main housing 301 has a straight-bar-like structure, the structure of the main housing is not limited thereto. It is apparent that the main housing may be configured into a foldable shape.) The main casing 301 has a portable telephone antenna 302.

Also, the main housing 301 has a proximity noncontact communication antenna unit 100. The external proximity noncontact communication device 400 performs proximity noncontact communication with the portable communication equipment 300 having the proximity noncontact communication function. Thus, a proximity noncontact communication antenna 401 is installed to a surface (a part corresponding to the bottom surface shown in FIG. 10) facing the portable communication equipment 300 in the proximity noncontact communication device 400.

Incidentally, the “proximity noncontact communication” referred to herein is communication utilizing an electric or magnetic field. A magnetic force and an electric force are a kind of forces conforming to Coulomb's law and feature that the magnetic force and the electric force are in inverse relation to a distance (that is, conform to an inverse-square law). Thus, the magnetic force and the electric force exponentially decrease in a short range. Accordingly, the term “proximity noncontact communication” is defined as communication preferably established in a proximity region, the distance from a field source to each point of which is equal to or less than about 10 cm by which the electric or magnetic field effectively acts.

Additionally, the portable telephone antenna 302 is an antenna for an ordinary portable telephone. The portable telephone antenna 302 is configured so that a portable telephone performs a call or data communication with a base station (not shown) by the portable telephone antenna 302.

A proximity noncontact communication antenna unit 100 is disposed as close as possible to a proximity noncontact communication surface (that is, at a portion corresponding to the top surface, as viewed in FIG. 10) in the main housing 301. The proximity noncontact communication antenna unit 100 is configured so that a proximity noncontact communication is performed between the proximity noncontact communication antenna unit 100 and the proximity noncontact communication antenna unit 400 of the external proximity noncontact communication device 400.

FIG. 1 is a cross-sectional view illustrating the proximity noncontact communication antenna unit 100, which is shown in FIG. 10, in detail. An antenna pattern 11 is formed on an antenna substrate 10. In a case where a surface of the antenna substrate 10, on which the antenna pattern 11 is formed, is directed to a communication direction, a bonding layer 12, a magnetic element 13, a bonding layer 14, and a magnetic element 15 are stacked in this order on the opposite surface thereof. Each of the bonding layers is constituted by a nonconductive double-sided adhesive tape or a nonconductive adhesive material layer, which has a relative magnetic permeability close to 1.

Additionally, the bonding layers 12 and 14 are made of the same material and have the same thickness, as shown in FIG. 1. However, the materials and the thicknesses of the bonding layers are not limited thereto. The bonding layers 12 and 14 may differ in material and thickness from each other.

Also, the magnetic elements 13 and 15 are made of the same material and have the same thickness, as shown in FIG. 1. However, the materials and the thicknesses of the magnetic materials are not limited thereto. The magnetic materials 13 and 15 may differ in material and thickness from each other.

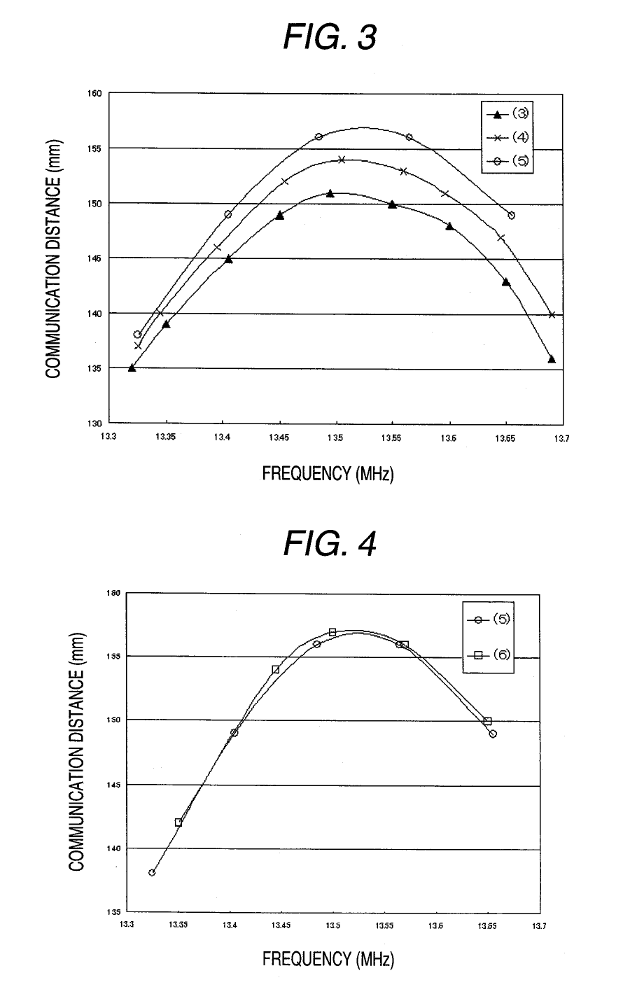

FIG. 3 shows reference results obtained by measurements. Curves (3) and (4) show communication distance characteristics in the case of proximity noncontact communication using the conventional antenna unit. A curve (5) shows a communication distance characteristic in the case of proximity noncontact communication using the antenna unit according to the present invention.

Also, the following conditions are employed to obtain the measurement results. That is, the magnetic elements 13,15, and 17 shown in FIGS. 1 and 11 are made of the same material. The communication distance characteristic (3) is obtained in a case where the thickness a of the magnetic element 17 is 0.28 mm. The communication distance characteristic (4) is obtained in a case where the thickness a of the magnetic element 17 is 0.35 mm. The communication distance characteristic (5) is obtained in a case where the thickness b of the magnetic element 13, the thickness c of the bonding layer 14, and the thickness d of the magnetic element 15 shown in FIG. 1 are 0.14 mm, 0.3 mm, and 0.14 mm, respectively. Additionally, the bonding layers 12,14, and 16 shown in FIGS. 1 and 11 are made of the same material and have the same thickness that is set to be 0.03 mm in this case.

The results shown in FIG. 3 reveal that although a total thickness of the magnetic element 13, the bonding layer 14, and the magnetic element 15 of the proximity noncontact communication antenna unit 100 having the communication distance characteristic (5) is substantially equal to the thickness of the magnetic element 17 of the proximity noncontact communication antenna unit 200 having the communication distance characteristic (3), the proximity noncontact communication antenna unit 200 according to the invention can ensure the more communication distance in the case of the proximity noncontact communication. Additionally, the thickness of the magnetic element 17 of the proximity noncontact communication antenna unit 200 having the communication distance characteristic (4) is larger than a sum of the thicknesses of the magnetic element 13, the bonding layer 14, and the magnetic element 15 of the proximity noncontact communication antenna unit 100 having the communication distance characteristic (5). However, the communication distance characteristic of the proximity noncontact communication antenna unit 100 having the communication distance characteristic (5) exceeds the communication distance characteristic of the proximity noncontact communication antenna unit 200 having the communication distance characteristic (4).

Also, FIG. 4 shows data in a case where the materials and the thickness of the bonding layer 12, and the magnetic elements 13 and 15 are not changed, and where only the thickness c of the bonding layer 14 is changed. The communication distance characteristic (5) corresponds to a case where the thickness c is set at 0.03 mm. The communication distance characteristic (6) corresponds to a case where the thickness c is set at 0.15 mm.

The results shown in FIG. 4 reveal that the thicker the bonding layer 14 shown in FIG. 1 becomes, the better communication distance characteristic in the case of the proximity noncontact communication can be ensured. Therefore, it is preferable that the thickness of the proximity noncontact communication antenna unit is increased within an allowable range.

Also, FIG. 6 shows measurement data representing communication distance characteristics in the case of the proximity noncontact communication, which differ from one another due to the differences in number of magnetic elements disposed on a surface of the antenna substrate 10, which is opposite to a communication surface thereof in the case of performing the proximity noncontact communication. The communication distance characteristic (3) corresponds to a case where the thickness a of the magnetic element 17 shown in FIG. 11 is 0.28 mm. The communication distance characteristic (8) corresponds to a case where the thickness b of the magnetic element 13 shown in FIG. 1 is 0.14 mm, where the thickness c of the bonding layer 14 shown in FIG. 1 is 0.03 mm, and where the thickness d of the magnetic element 15 shown in FIG. 1 is 0.07 mm. The communication distance characteristic (9) corresponds to a case where the thickness b of the magnetic element 13 shown in FIG. 1 is 0.07 mm, where the thickness c of the bonding layer 14 shown in FIG. 1 is 0.03 mm, where the thickness d of the magnetic element 15 shown in FIG. 1 is 0.07 mm, and where a bonding layer having a thickness of 0.03 mm and a magnetic element having a three-layer structure and also having a thickness of 0.07 mm are provided on the surface of the antenna substrate 10, which is opposite to the surface on which the magnetic element 15 is provided. Incidentally, although the magnetic elements used to obtain the communication distance characteristics (3), (8), and (9) differ in thickness from one another, the same material is used as that of the magnetic elements. The bonding layer 12 provided between the antenna substrate 10 and the magnetic element 13 and the bonding layer 16 provided between the antenna substrate 10 and the magnetic element 17 are made of the same material and have the same thickness. Bonding layers, which are the same as the bonding layers 12 and 16, are employed as the bonding layers 14 used in the proximity noncontact communication antenna units respectively having the communication distance characteristics (8) and (9) and as the bonding layer added to the proximity noncontact communication antenna unit having the communication distance characteristic (9).

Results of the measurements shown in FIG. 6 reveal that although the thicknesses of the magnetic elements of the proximity noncontact communication antenna units respectively having the communication distance characteristics (3), (8), and (9) are substantially equal to one another, the larger the number of stacked magnetic elements is, the longer the communication distance in the case of the proximity noncontact communication is ensured. Thus, preferably, the number of magnetic elements is increased within an allowable range of the thickness of the proximity noncontact communication antenna unit.

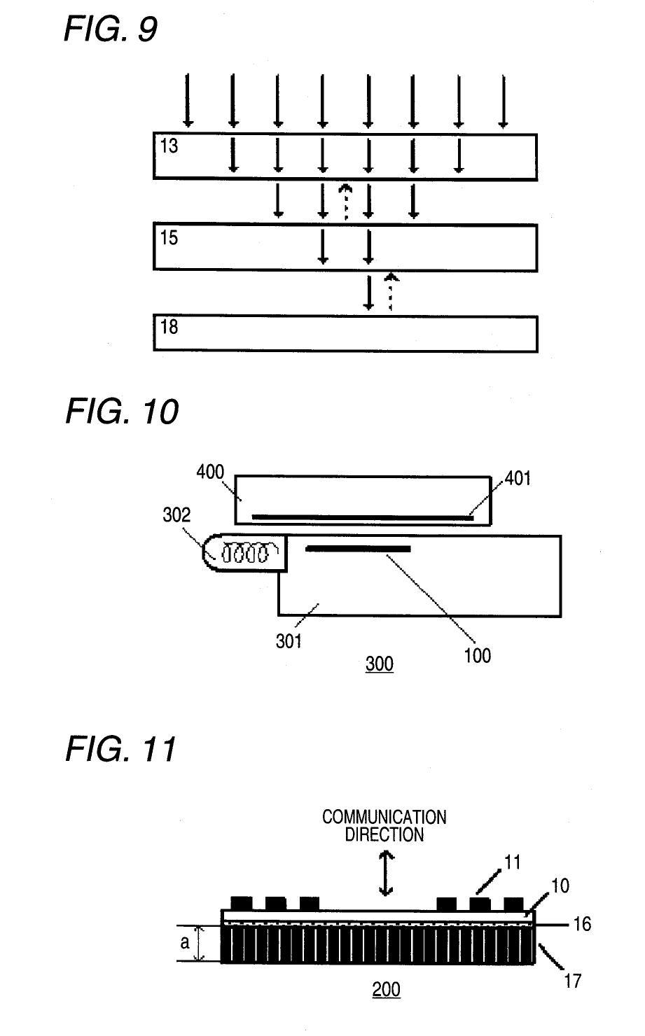

Also, FIG. 8 is a view illustrating the distribution of a magnetic field according to the prior art. FIG. 9 is a view illustrating the distribution of a magnetic field according to each of the first embodiment and second and third embodiments of the invention.

In a case where a magnetic field is present in a portion to a part corresponding to the bottom surface of the magnetic element 17 from a part corresponding to the top surface of the magnetic element 17, as shown in FIG. 8, and where an electrically conductive material 18 is present at a portion corresponding to a lower part of the magnetic element 17, the magnetic field is reflected as indicated by dashed arrows. Thus, reflection waves reach the antenna substrate provided on the part corresponding to the top surface through the magnetic element 17 again. In this case, the original magnetic field is weakened, so that the communication distance in the case of the proximity noncontact communication is reduced.

In a case where a magnetic field is present in a portion to a part corresponding to the bottom surface of the magnetic element 13 from a part corresponding to the top surface of the magnetic element 13 shown in FIG. 9, and where an electrically conductive material 18 is present at a portion corresponding to a lower part of the magnetic element 13, the magnetic field is attenuated between the magnetic elements 13 and 15. Thus, waves reflected by the electrically conductive material 18, which weaken the original magnetic field, are reduced. This prevents the communication distance in the case of the proximity noncontact communication.

According to the first embodiment, the proximity noncontact communication antenna unit is constituted by including the proximity noncontact communication antenna substrate and a plurality of magnetic elements. Thus, the first embodiment according to the invention has the following advantages. That is, the reflection of the magnetic field and the generation of an eddy current, which affect the proximity noncontact communication characteristics, can be reduced. Consequently, the communication distance characteristics at the proximity noncontact communication can be stabilized. Accordingly, the proximity noncontact communication antenna unit can be reduced in thickness. Also, even when a portable communication equipment has the proximity noncontact communication function, desired communication characteristics can be ensured.

### Second Embodiment

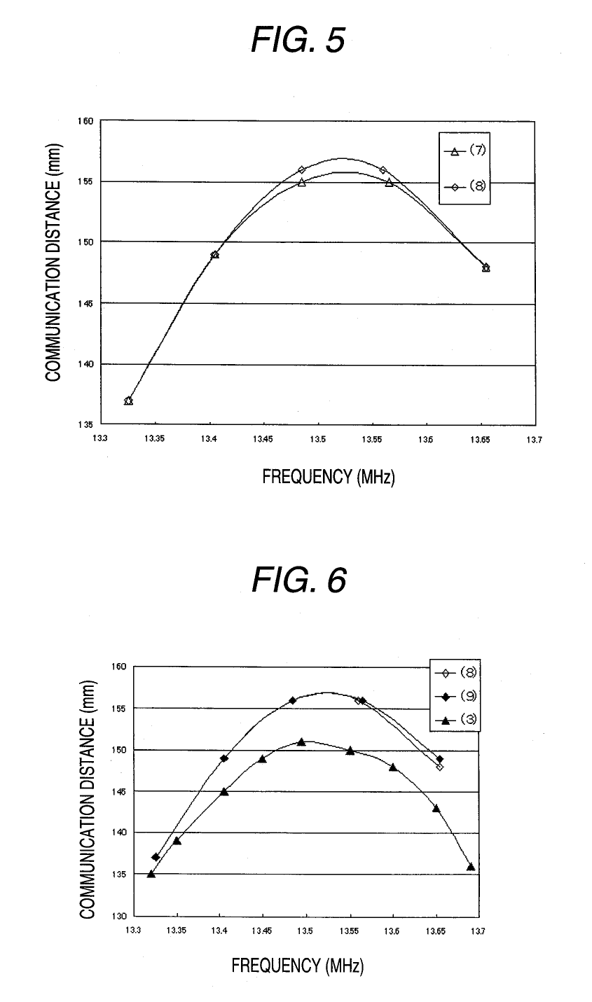

A proximity noncontact communication antenna unit 100 according to a second embodiment of the invention is described below with reference to FIGS. 1 and 5. Incidentally, the description of parts of the second embodiment, which overlap with corresponding parts of the first embodiment, is omitted.

FIG. 5 shows measurement data in a case where the magnetic elements 13 and 15 shown in FIG. 1 are made of the same material and differ in thickness from each other. In the cases respectively obtaining communication distance characteristics (7) and (8), the antenna unit 100 shown in FIG. 1 has the same antenna substrate 10, the same antenna pattern 11, the same bonding layer 12, and the same bonding layer 14. In the case of obtaining the communication distance characteristic (7), the thickness d of the magnetic element 13 is 0.07 mm, and the thickness d of the magnetic element 15 is 0.14 mm. In the case of obtaining the communication distance characteristic (8), the thickness b of the magnetic element 13 is 0.14 mm, and the thickness d of the magnetic element 15 is 0.07 mm. In the cases of obtaining the communication distance characteristics (7) and (8), the magnetic elements, all of which employ the same material, are used.

Results shown in FIG. 5 reveal that the communication distance characteristic in the case of performing the proximity noncontact communication can be enhanced by arranging, even when the thickness of the antenna unit 100 has the same thickness, the plurality of magnetic elements in the descending order of thickness from the side of the antenna substrate 10.

Although it has been described that the bonding layers 12 and 14 shown in FIG. 1 are made of the same material and have the same thickness, the bonding layers according to the second embodiment are not limited thereto. The bonding layers according to the invention may differ from each other in material and thickness.

Although it has been described that the antenna unit 100 includes the two magnetic elements 13 and 15, the configuration of the antenna unit 100 is not limited thereto. The antenna unit may include three or more magnetic elements. Incidentally, preferably, in a case where the antenna unit includes a plurality of magnetic elements differing in thickness from one another, the magnetic elements are arranged in the descending order of thickness from the side of the antenna substrate 10.

According to the second embodiment, the proximity noncontact communication antenna unit is constituted by including the proximity noncontact communication antenna substrate and a plurality of magnetic elements. In a case where the magnetic elements differ in thickness from one another, the magnetic elements are arranged in the descending order of thickness from the side of the antenna substrate. Thus, the second embodiment according to the invention has the following advantages. That is, the reflection of the magnetic field and the generation of an eddy current, which affect the proximity noncontact communication characteristics, can be reduced. Consequently, the communication distance characteristics at the proximity noncontact communication can be stabilized. Accordingly, the proximity noncontact communication antenna unit can be reduced in thickness. Also, even when a portable communication equipment has the proximity noncontact communication function, desired communication characteristics can be ensured.

### Third Embodiment

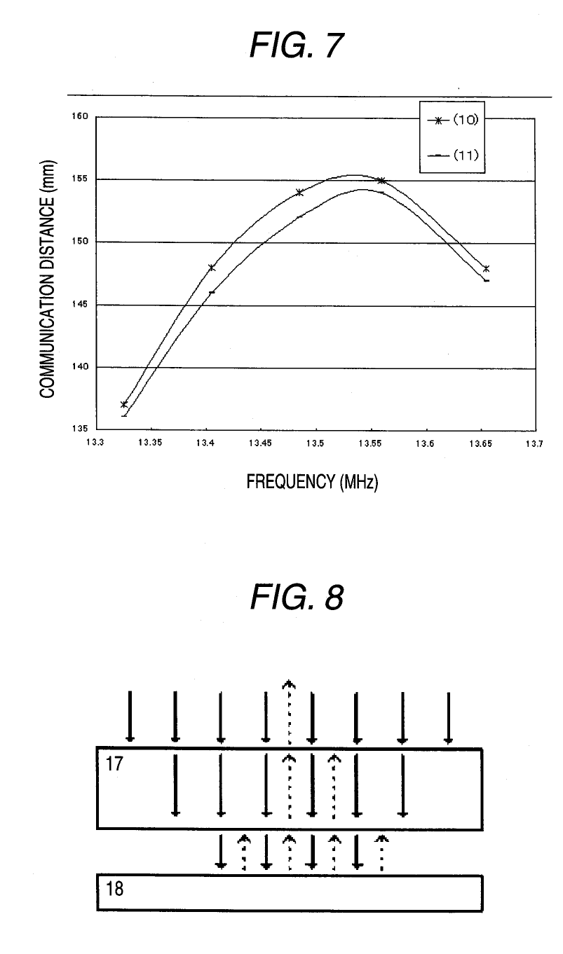

A proximity noncontact communication antenna unit 100 according to a third embodiment of the invention is described below with reference to FIGS. 1 and 7. Incidentally, the description of parts of the second embodiment, which overlap with corresponding parts of the first embodiment, is omitted.

FIG. 7 shows measurement data in a case where the magnetic elements 13 and 15 shown in FIG. 1 are made of the same material and differ in magnetic permeability from each other. In the cases respectively obtaining communication distance characteristics (10) and (11), the antenna unit 100 shown in FIG. 1 has the same antenna substrate 10, the same antenna pattern 11, the same bonding layer 12, and the same bonding layer 14. In the case that the antenna unit 100 has the communication distance characteristic (10), the magnetic permeability of the magnetic element 13 is 65, and that of the magnetic element 15 is 35. In the case that the antenna unit 100 has the communication distance characteristic (11), the magnetic permeability of the magnetic element 13 is 35, and that of the magnetic element 15 is 60. In the cases of the antenna units 100 respectively having the communication distance characteristics (10) and (11), the magnetic elements, the thicknesses of which are 0.14 mm, are used.

Results shown in FIG. 7 reveal that the more communication distance in the case of performing the proximity noncontact communication can be ensured by arranging, even when a total thickness of the magnetic elements of the antenna unit 100 has the same value, the plurality of magnetic elements in the descending order of magnetic permeability from the side of the antenna substrate 10.

Although it has been described that the bonding layers 12 and 14 shown in FIG. 1 are made of the same material and have the same thickness, the bonding layers according to the third embodiment are not limited thereto. The bonding layers according to the invention may differ from each other in material and thickness.

Although it has been described that the antenna unit 100 includes the two magnetic elements 13 and 15, the configuration of the antenna unit 100 is not limited thereto. The antenna unit may include three or more magnetic elements. Incidentally, preferably, in a case where the antenna unit includes a plurality of magnetic elements differing in magnetic permeability from one another, the magnetic elements are arranged in the descending order of magnetic permeability from the side of the antenna substrate 10.

According to the second embodiment, the proximity noncontact communication antenna unit is constituted by including the proximity noncontact communication antenna substrate and a plurality of magnetic elements. In a case where the magnetic elements differ in magnetic permeability from one another, the magnetic elements are arranged in the descending order of magnetic permeability from the side of the antenna substrate. Thus, the third embodiment according to the invention has the following advantages. That is, the reflection of the magnetic field and the generation of an eddy current, which affect the proximity noncontact communication characteristics, can be reduced. Consequently, the communication distance characteristics at the proximity noncontact communication can be stabilized. Accordingly, the proximity noncontact communication antenna unit can be reduced in thickness. Also, even when a portable communication equipment has the proximity noncontact communication function, desired communication characteristics can be ensured.

What is claimed is:

1. An antenna unit, comprising:
a noncontact communication antenna; and
a plurality of magnetic elements,
wherein the antenna and the magnetic elements are disposed so that the magnetic elements are superposed on the antenna.

2. The antenna unit according to claim 1, wherein the magnetic elements are different in thickness from one another; and
wherein the magnetic elements are disposed so that the magnetic element placed relatively closer to the antenna is greater in the thickness than the magnetic element placed relatively further from the antenna.

3. The antenna according to claim 1, wherein the magnetic elements are different in magnetic permeability from one another; and
wherein the magnetic elements are disposed so that the magnetic element placed relatively closer to the antenna is greater in the magnetic permeability than the magnetic element placed relatively further from the antenna.

4. The antenna according to claim 2, wherein the magnetic elements are different in magnetic permeability from one another; and
wherein the magnetic elements are disposed so that the magnetic element placed relatively closer to the antenna is greater in the magnetic permeability than the magnetic element placed relatively further from the antenna.

5. A portable communication equipment comprising the antenna unit according to claim 1, which is mounted thereon.
